(19) United States
(12) Patent Application Publication
(10) Pub. No.: US 2025/0319775 A1
(43) Pub. Date: Oct. 16, 2025

(54) Rail Vehicle Roof with Electric Roof Equipment, and Rail Vehicle

(71) Applicant: Siemens Mobility Austria GmbH, Wien (AT)

(72) Inventors: Christian SALIGER, Wien (AT); John BEKHIT, Wien (AT); Georg HAVLICEK, Wien (AT)

(21) Appl. No.: 18/867,969

(22) PCT Filed: May 23, 2023
(86) PCT No.: PCT/EP2023/063737

§ 371 Date: Nov. 21, 2024

(30) Foreign Application Priority Data
May 25, 2022 (AT) A50367/2022

(51) Int. Cl. B60L 3/04; B60L 5/26; B60L 5/28; H01H 31/30; H01H 31/36

(52) U.S. Cl. CPC B60L 3/04; B60L 5/26; B60L 5/28; H01H 31/30; H01H 31/36; B60L 2200/26

(57) ABSTRACT

A rail vehicle roof with electric roof equipment having at least one disconnect switch includes at least a first insulator, to which an electrically conductive disconnector is connected, and a second insulator with an electrically conductive first contacting device for connection to the disconnector, where the at least one disconnect switch is connected to the rail vehicle roof, where at least the first insulator is arranged at an angle to a vertical axis of the rail vehicle roof, and where the first insulator is arranged rotated about a parallel to a longitudinal axis of the rail vehicle roof such that an extent of the disconnect switch in the direction of the vertical axis is reduced.

### CROSS-REFERENCE TO RELATED APPLICATIONS

This is a U.S. national stage of application No. PCT/EP2023/063737 filed 23 May 2023. Priority is claimed on Austrian Application No. A50367/2022 filed 25 May 2022, the content of which is incorporated herein by reference in its entirety.

### BACKGROUND OF THE INVENTION

### 1. Field of the Invention

The invention relates to a rail vehicle roof with electrical roof equipment having at least one disconnect switch, comprising at least one first insulator to which an electrically conductive disconnector is connected, and a second insulator with an electrically conductive first contacting device for connection to the disconnector, where the at least one disconnect switch is connected to the rail vehicle roof, and where at least the first insulator is disposed at an angle to a vertical axis of the rail vehicle roof.

### 2. Description of the Related Art

Rail vehicles often have rail vehicle roofs upon which various items of electrical roof equipment are disposed (e.g., disconnect switches, pantographs, insulators, power lines, and/or transformers).

Disconnect switches are often used to interrupt a flow of current (e.g., through a power line). When a disconnect switch is actuated, the current flow is interrupted. This allows a pantograph, for example, to be electrically isolated from other components of a rail vehicle.

Components on rail vehicle roofs must maintain a minimum distance from the loading gauge limit. In addition, live components in the vicinity of a pantograph must be disposed in a defined zone in that area. For example, a live component must have a minimum distance from a grounded pantograph when retracted to avoid voltage flashovers. In addition, protection against electric shock must be ensured for pantographs, for which reason high-voltage components must be disposed within a corridor defined by the movement profile of a pantograph collector head.

Corresponding requirements with respect to loading gauge, protection against electric shock, insulation clearance and creepage distances, etc., combined with space constraints on rail vehicle roofs, often result in conflicting design objectives. These conflicting design objectives are particularly relevant, for example, in connection with roof equipment components that are disposed in a roof well for aerodynamic reasons.

As a known example from the prior art, WO 2010/003834 A1 describes a pantograph and a disconnector for a rail vehicle. The pantograph and the disconnector are powered via a hydraulic drive. A disconnecting blade of the disconnector is rotatably and displaceably connected to a first pole. When the disconnector is in the closed position, the disconnecting blade is connected to a second pole, which is in turn connected to a transformer of the rail vehicle. When the disconnector is in the open position, the disconnecting blade can either be connected to the first pole and no other pole or to the first pole and a third pole. The third pole is connected to the grounding system of the rail vehicle.

Moreover, EP 2 910 399 B1 shows a roof-mounted pantograph for a rail vehicle, where the pantograph is supported on three vertically aligned insulators. The roof-mounted pantograph is connected to a pneumatic actuating device and has an electrically conductive lower arm, a coupling rod, an upper arm made of a composite material, an electrically conductive steady arm tube and a current collector head, which are coupled to one another.

### SUMMARY OF THE INVENTION

It is an object of the invention is provide an improved rail vehicle roof having electrical roof equipment that can be used to meet requirements in terms of loading gauge, protection against electric shock, and/or insulation clearance and creepage distances, even when installation space is limited.

This and other objects and advantages are achieved in accordance with the invention by a rail vehicle roof having electrical roof equipment, in which the first insulator is disposed in a rotated position about an axis parallel to a longitudinal axis of the rail vehicle roof.

This reduces the overall height of the disconnect switch in the direction of the vertical axis. An inventively inclined orientation of the disconnect switch allows a drive unit for the disconnect switch to be disposed at an angle below the first insulator instead of directly under it. The reduced overall height of the disconnector in the direction of the vertical axis reduces the risk of exceeding a loading gauge limit. Compared to a horizontal arrangement of insulators, for example, the angled arrangement of the first insulator also makes it easier to maintain the necessary air gaps between the first insulator and, e.g., the roof of the rail vehicle. While spacers, for example, must be used on a vehicle roof when insulators are disposed horizontally, the inventive angled arrangement of the first insulator makes it possible to dispense with such additional components (e.g., spacers and/or supports). This measure also means that the first insulator is disposed at an angle in a transverse plane of the rail vehicle roof.

It can be useful if the first insulator is connected to the rail vehicle roof so as to rotate about a longitudinal axis of the first insulator. This allows rotary movements to be used for circuit breaking and making operations of the disconnect switch.

In a preferred embodiment, the disconnector is fixedly connected to the first insulator so as to project from the insulator longitudinal axis. In this context, it is advantageous if the disconnector is angled downward when the at least one disconnect switch is in an open state. These measures increase operational safety, because the open state of the disconnector is achieved by a downward movement of the disconnect switch and thus with the assistance of a gravitational component acting on the disconnector.

Grounding of the electrical roof equipment is provided when the disconnector, in the open state of the at least one disconnect switch, is connected to a grounding device of the at least one disconnect switch, where the grounding device is connected to the rail vehicle roof.

By the disconnector being angled downward in the open state of the disconnect switch, the grounding device, to which, e.g., a grounding line can be connected, can be of compact configuration and of minimal extent in the direction of the vertical axis.

In addition, it is advantageous if the at least one disconnect switch has a disconnect drive, connected to the first insulator, for rotating the first insulator, where the drive is disposed on a side facing the rail vehicle roof, and where the longitudinal axis of the insulator and a drive axis of the disconnect drive are oriented parallel to one another.

This measure allows the disconnect drive to be mounted as an extension of the first insulator and thus, like the first insulator, disposed at an angle with respect to the vertical axis. The disconnect drive, which can be formed, e.g., as a battery-powered electric servo drive or as a pneumatic drive, can thus be disposed at an angle below the first insulator instead of directly under it, thereby reducing the overall length made up of a first length of the first insulator plus a second length of the disconnect drive in the direction of the vertical axis.

In an advantageous embodiment, an upper end of the first insulator is disposed closer to a longitudinal center plane of the rail vehicle roof, i.e., the plane of the vertical axis, than a lower end of the first insulator. As a result, the upper end of the first insulator is inclined toward the center of the rail vehicle roof, i.e., not toward an outer side. This reduces risks of the first insulator exceeding a loading gauge which, in the transverse plane of the rail vehicle roof, extends from a distance from the rail vehicle roof in the direction of the vertical axis, down toward lateral flanks of the rail vehicle roof. If the disconnector is connected to the first insulator, then this measure can provide increased flexibility for movements of the disconnector, without exceeding the gauge limits.

In a preferred embodiment, the at least one disconnect switch is electrically connected to a current-carrying arm of a pantograph connected to the rail vehicle roof, where the current-carrying arm is of different configuration than a lower arm of the pantograph or a lower frame of the pantograph.

The separate current-carrying arm provides a high degree of flexibility for arranging components of the electrical roof equipment on the rail vehicle roof. For example, insulators of the pantograph can thus be disposed laterally offset from a base frame of the pantograph. In addition, the separate current-carrying arm makes it possible for the lower arm or the lower frame to be made of an electrically non-conductive composite material, for example, thereby enabling pantograph mass to be reduced.

Advantageous mobility of the current-carrying arm is achieved and excessive restriction of pantograph movement by the current-carrying arm is avoided if the current-carrying arm is structured to be telescopically adjustable in length and is connected in an articulated manner to the rail vehicle roof and in an articulated manner to a connecting element of the pantograph, via at least a first lower arm of the pantograph is coupled to an upper arm of the pantograph in an articulated manner.

A continuous supply of current from a power source (e.g., an overhead line) to the electrical roof equipment including the current-carrying arm is made possible if an electrically insulating lower frame of the pantograph is formed from the first lower arm and a second lower arm of the pantograph, where the connecting element and the upper arm are configured to be electrically conductive.

A lightweight and at the same time very stable pantograph is achieved when the upper arm is connected to a vertex arm of the pantograph that is coupled to a collector head of the pantograph, where a first connecting strut is disposed between a first flank of the upper arm and the vertex arm and a second connecting strut is disposed between a second flank of the upper arm, which flank is disposed opposite the first flank, and the vertex arm. The first connecting strut and the second connecting strut increase the rigidity of the pantograph.

In a further advantageous embodiment, the current-carrying arm is connected in an articulated manner to a third insulator of the pantograph, where the third insulator is disposed rotated about an axis parallel to a transverse axis of the rail vehicle roof and at an angle to the vertical axis, and where the at least one disconnect switch and the pantograph are disposed in a recess in the rail vehicle roof.

The effect of this measure is that the pantograph with its associated third insulator does not project at all, or projects only slightly, beyond an upper edge of the recess when the pantograph is in a lowered position, thereby enabling air resistance to be reduced and thus improved aerodynamics to be achieved. Disposing the third insulator at an angle ensures that an upper end of the third insulator, an end via which an electrical conductor may be routed, for example, can maintain a sufficient safety distance from other components of the pantograph (such as the collector head), even when the pantograph is in a lowered position.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in more detail below with reference to exemplary embodiments, in which:

FIG. 1: shows a schematic front view of a section of a rail vehicle with an exemplary first embodiment of an inventive rail vehicle roof with electrical roof equipment, comprising a disconnect switch with insulators disposed at an angle and a pantograph with a separate current-carrying arm that is connected to the disconnect switch, where the disconnect switch is in an open state; and

FIG. 2: shows a schematic side view of a section of a rail vehicle with an exemplary second embodiment of an inventive rail vehicle roof with electrical roof equipment comprising a disconnect switch, where the disconnect switch is in a closed state.

### DETAILED DESCRIPTION OF THE EXEMPLARY EMBODIMENTS

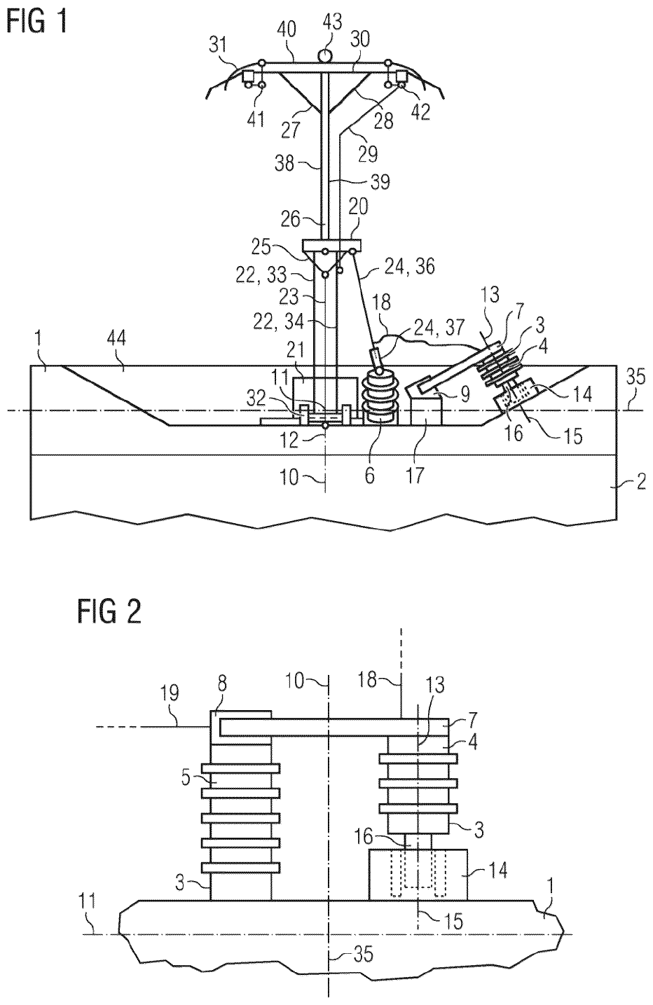

FIG. 1 schematically illustrates a section of a rail vehicle in a cutaway view with an exemplary first embodiment of a rail vehicle roof 1 in accordance with the invention with electrical roof equipment. The rail vehicle comprises a car body 2 with the rail vehicle roof 1.

The electrical roof equipment has a disconnect switch 3 connected to the rail vehicle roof 1, where the disconnect switch comprises a first insulator 4 and a second insulator 5 (not shown in FIG. 1 but shown by way of example in FIG. 2). An electrically conductive disconnector 7 in the form of a disconnecting blade is connected to the first insulator 4. The second insulator 5 comprises an electrically conductive first contacting device 8 to which the disconnector 7 can be connected via a pivoting movement.

The first insulator 4 and the second insulator 5 are disposed at an angle to a vertical axis 10 of the rail vehicle roof 1, rotated about an axis parallel to a longitudinal axis 11 (shown in projected form in FIG. 1) of the rail vehicle roof 1. An upper end of the first insulator 4 is disposed closer to a longitudinal center plane 12 (shown in projected form in FIG. 1) of the rail vehicle roof 1 than a lower end of the first insulator 4, where the longitudinal center plane 12 contains the vertical axis 10 and the longitudinal axis 11. The upper end of the first insulator 4 thus faces the longitudinal center plane 12.

The first insulator 4 is connected to the rail vehicle roof 1 such that it can rotate about a longitudinal axis 13 of the first insulator 4. A disconnect drive 14 of the disconnect switch 3 is coupled to the first insulator 4 to initiate rotational movements of the first insulator 4, via which movements the disconnector 7 can be switched from a closed state to an open state and vice versa. The disconnect drive 14 is disposed at an angle below the first insulator 4 on a side facing the rail vehicle roof 1, where the longitudinal axis 13 of the insulator and a drive axis 15 of the disconnect drive 14 are aligned so as to coincide. A drive shaft 16 of the disconnect drive 14 is fixedly connected to the first insulator 4.

The disconnect drive 14 is formed as an electric servo drive that is controlled via the rail vehicle and powered via a battery (not shown in FIG. 1) in the rail vehicle. In accordance with the invention, it is also conceivable for the disconnect drive 14 to be designed as a pneumatic drive, for example, which is pneumatically supplied by a compressed air supply facility of the rail vehicle.

The disconnector 7 is fixedly connected to the first insulator 4 and perpendicular to the longitudinal axis 13 of the insulator and is angled downward in the open state of the disconnect switch 3, as shown in FIG. 1. In the open state of the disconnect switch 3, the disconnector 7 is coupled to a grounding device 17 of the disconnect switch 3, where the grounding device is connected to the rail vehicle roof 1. The disconnector 7 is engaged in a second contacting device 9, formed as a clamp, of the grounding device 17. The grounding device 17 is connected to the rail vehicle's ground conductor (not shown in FIG. 1) via which the electrical roof equipment is grounded.

In accordance with the invention, it is also conceivable for the grounding device 17 to be dispensed with, where the disconnector 7 is also angled downward in the open state, but in so doing does not make contact with any other components of the rail vehicle apart from the first insulator 4 and an electrical first power line 18.

In order to connect the disconnector 7 to the first contacting device 8 of the second insulator 5, i.e., to place the disconnect switch 3 into the closed state, as shown by way of example in FIG. 2, the first insulator 4 is rotated counterclockwise via the disconnect drive 14, which causes the disconnector 7 to swing out and engage in the first contacting device 8 at the end of such a rotation process.

When the disconnect switch 3 is in the closed state, current can flow from the disconnector 7 via the first contacting device 8, thereby for example enabling electrical loads (not shown in FIG. 1) of the rail vehicle (e.g., a traction motor of the rail vehicle) to be supplied with electricity.

The electrical equipment on the roof of the rail vehicle also includes a pantograph 20 comprising a pantograph drive 21, a third insulator 6 and additional insulators (not shown in FIG. 1), a lower frame 22, a coupling rod 23, a current-carrying arm 24, a connecting element 25, an upper arm 26, a first connecting strut 27, a second connecting strut 28, a steady arm tube 29, an apex arm 30 with two horns, a collector head 31 and a plurality of articulated joints.

The pantograph drive 21 used to raise and lower the pantograph 20 is structured as a pneumatic drive with air bellows and is coupled to a base joint 32 that is connected to the lower frame 22. The pantograph drive 21 is controlled via the rail vehicle and is supplied with compressed air by a compressed air supply facility (not shown in FIG. 1) of the rail vehicle.

A movable part of the base joint 32 can be actuated via the pantograph drive 21. The movable part of the base joint 32 is fixedly connected to the lower frame 22, which means that when the movable part of the base joint 32 is actuated, triggering rotation of the movable part of the base joint 32, the lower frame 22 pivots upward into a raised position of the pantograph 20 or downward into a lowered position of the pantograph 20. The pantograph drive 21 and the base joint 32 are mounted on the rail vehicle roof 1.

The lower frame 22 comprises a first lower arm 33 and a second lower arm 34 and is connected in an articulated manner to the upper arm 26 via the connecting element 25, where the upper arm 26 is fixedly connected to the connecting element 25. The coupling rod 23 is coupled in an articulated manner, on the one hand, to the rail vehicle roof 1 and, on the other, in an articulated manner to the connecting element 25, which means that the coupling rod 23 follows movements of the lower frame 22.

The current-carrying arm 24 is configured differently than the lower frame 22 and the coupling rod 23, i.e., implemented as a separate component, and is connected in an articulated manner to the third insulator 6 which, rotated about an axis parallel to a transverse axis 35 of the rail vehicle roof 1, is disposed at an angle to the vertical axis 10, fixedly connected to the rail vehicle roof 1, and connected in an articulated manner to the connecting element 25. As a result, the current-carrying arm 24 follows movements of the lower frame 22. The current-carrying arm 24 has a telescopic rod 36 and a telescopic tube 37, where the telescopic rod 36 is displaceable within the telescopic tube 37. The current-carrying arm 24 is therefore adjustable in length.

In accordance with the invention, it is also conceivable for the current-carrying arm 24 to be formed in one-piece and to be connected, for example, to the third insulator 6 or to the connecting element 25 via a spring.

The upper arm 26 is formed as the sole upper arm of the pantograph 20 and is fixedly connected to the apex arm 30. The first connecting strut 27 is disposed between a first flank 38 of the upper arm 26 and the apex arm 30, while the second connecting strut 28 is located between a second flank 39, disposed opposite the first flank 38, of the upper arm 26 and the apex arm 30. The first connecting strut 27 and the second connecting strut 28 are fixedly connected to the upper arm 26 and the apex arm 30.

The collector head 31 is coupled in an articulated manner to the apex arm 30. The collector head 31 comprises a first contact strip 40 and a second contact strip (not visible in FIG. 1) which are connected to the apex arm 30 in an articulated manner and so as to be displaceable relative to the apex arm 30 in the direction of the vertical axis 10 via a first lever arrangement 41 of the collector head 31, a second lever arrangement 42 of the collector head 31, and further lever arrangements (not visible in FIG. 1). In the raised state of the pantograph 20 shown in FIG. 1, the first contact strip 40 and the second contact strip are in contact with an overhead line 43.

The collector head 31 is supported, guided and protected against impermissible tilting via the steady arm tube 29 that is connected to both the lower frame 22 and the collector head 31 in an articulated manner.

Due to the articulated connections of the lower frame 22 and of the coupling rod 23 to the upper arm 26 (via the connecting element 25) and of the lower frame 22 to the steady arm tube 29, and due to the supporting of the collector head 31 by the steady arm tube 29, the upper arm 26 and the collector head 31 follow movements of the lower frame 22. As a result, actuation of the pantograph drive 21 causes the collector head 31 to be raised to make contact with the overhead line 43 or to move the pantograph 20 into a folded position, lowered onto the rail vehicle roof 1.

When the pantograph 20 is raised and placed against the overhead line 43, current can flow from the overhead line 43 via the collector head 31, the apex arm 30, the first connecting strut 27, the second connecting strut 28, the upper arm 26, the connecting element 25 and the current-carrying arm 24, which are made of electrically conductive, metallic materials. The lower frame 22 is made of an electrically insulating material, a fiber-reinforced plastic. The coupling rod 23 is also made of an electrically insulating material, a fiber-reinforced plastic.

In the raised state of the pantograph 20, placed against the overhead contact line 43, and in the closed state of the disconnect switch 3, current can flow from the current-carrying arm 24 via the first power line 18, which electrically connects the current-carrying arm 24 to the disconnector 7, and via the disconnector 7, the first contacting device 8 and an electrical second power line 19, not depicted in FIG. 1 but shown by way of example in FIG. 2 and electrically connected to the first contacting device 8, to the electrical loads of the rail vehicle.

The disconnect switch 3 and the pantograph 20 are disposed in a trapezoidal recess 44 in the rail vehicle roof 1.

FIG. 2 is a schematic sectional side view of a section of a rail vehicle, showing an exemplary second embodiment of an inventive rail vehicle roof 1 containing electrical roof equipment.

The sectional view is rotated from a horizontal view about a longitudinal axis 11 of the rail vehicle roof 1, which is why a transverse axis 35 of the rail vehicle roof 1 in FIG. 2 does not appear in a projecting manner, but as extending in a vertical axis 10 of the rail vehicle roof 1.

The electrical roof equipment comprises a disconnect switch 3 having a first insulator 4 and a second insulator 5. An electrically conductive disconnector 7 in the form of a disconnecting blade is fixedly connected to the first insulator 4. The second insulator 5 comprises an electrically conductive first contacting device 8 to which the disconnector 7 is connected. FIG. 2 thus shows the disconnect switch 3 in a closed state.

As also described by way of example in connection with FIG. 1, the first insulator 4 and the second insulator 5 are disposed at an angle to the vertical axis 10, rotated about axes parallel to the longitudinal axis 11.

With a disconnect drive 14, described by way of example in connection with FIG. 1, having a drive shaft 16 that is fixedly connected to the first insulator 4, the first insulator 4 is rotatable about an insulator longitudinal axis 13 that extends in a drive axis 15 of the disconnect drive 14, as a result of which the disconnector 7 can be pivoted from the closed state of the disconnect switch 3 into an open state of the disconnect switch 3, and the disconnector 7 can be pivoted from the open state of the disconnect switch 3 into an closed state of the disconnect switch 3, as shown by way of example in FIG. 1.

The second insulator 5 is fixedly connected to the rail vehicle roof 1. The first insulator 4 is connected to the rail vehicle roof 1 via the disconnect drive 14. An electrical first power line 18 is electrically connected to the disconnector 7, and the first power line 18 is in turn electrically connected to a pantograph 20, as shown by way of example in FIG. 1. The disconnector 7 is electrically connected to the first contacting device 8. The first contacting device 8 is in turn electrically connected to an electrical second power line 19. Via the second power line 19, which is electrically connected to electrical loads of the rail vehicle (not shown in FIG. 2), in the closed state of the disconnect switch 3, the loads can be supplied with current collected via the pantograph 20 from an overhead line 43, as shown by way of example in FIG. 1.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements that perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

The invention claimed is:

1.-14. (canceled)

15. A rail vehicle roof with electrical roof equipment having at least one disconnect switch, the rail vehicle roof comprising:
at least a first insulator to which an electrically conductive disconnector is connected; and
a second insulator having an electrically conductive first contacting device for connection to the at least one disconnector;
wherein the at least one disconnect switch is connected to the rail vehicle roof;
wherein at least the first insulator is disposed at an angle to a vertical axis of the rail vehicle roof; and
wherein the first insulator is disposed rotated about an axis parallel to a longitudinal axis of the rail vehicle roof.

16. The rail vehicle roof with electrical roof equipment as claimed in claim 15, wherein the first insulator is connected to the rail vehicle roof such that the first insulator is rotatable about a longitudinal axis of the first insulator.

17. The rail vehicle roof with electrical roof equipment as claimed in claim 16, wherein the electrically conductive disconnector is fixedly connected to the first insulator such that the electrically conductive disconnector projects from the insulator longitudinal axis.

18. The rail vehicle roof with electrical roof equipment as claimed in claim 17, wherein the electrically conductive disconnector is angled downward when the at least one disconnect switch is in an open state.

19. The rail vehicle roof with electrical roof equipment as claimed in claim 18, wherein the electrically conductive disconnector is connected to a grounding device of the at least one disconnect switch when the at least one disconnect switch is in the open state, said grounding device being connected to the rail vehicle roof.

20. The rail vehicle roof with electrical roof equipment as claimed in claim 16, wherein the electrically conductive disconnector is connected to the first contacting device of the second insulator when the at least one disconnect switch is in a closed state.

21. The rail vehicle roof with electrical roof equipment as claimed in claim 17, wherein the electrically conductive disconnector is connected to the first contacting device of the second insulator when the at least one disconnect switch is in a closed state.

22. The rail vehicle roof with electrical roof equipment as claimed in claim 18, wherein the electrically conductive disconnector is connected to the first contacting device of the second insulator when the at least one disconnect switch is in a closed state.

23. The rail vehicle roof with electrical roof equipment as claimed in claim 19, wherein the electrically conductive disconnector is connected to the first contacting device of the second insulator when the at least one disconnect switch is in a closed state.

24. The rail vehicle roof with electrical roof equipment as claimed in claim 16, wherein the at least one disconnect switch includes a disconnect drive connected to the first insulator to rotate the first insulator, said disconnect drive being disposed on a side facing the rail vehicle roof; and wherein the longitudinal axis of the insulator and a drive axis of the disconnect drive are aligned parallel to one another.

25. The rail vehicle roof with electrical roof equipment as claimed in claim 15, wherein an upper end of the first insulator is disposed closer to a longitudinal center plane of the rail vehicle roof, said plane containing the vertical axis, than a lower end of the first insulator.

26. The rail vehicle roof with electrical roof equipment as claimed in claim 15, wherein the at least one disconnect switch is electrically connected to a current-carrying arm of a pantograph connected to the rail vehicle roof; and wherein the current-carrying arm is of different configuration than a lower arm of the pantograph or a lower frame of the pantograph.

27. The rail vehicle roof with electrical roof equipment as claimed in claim 26, wherein the current-carrying arm has a telescopically adjustable length and is connected in an articulated manner to the rail vehicle roof and in an articulated manner to a connecting element of the pantograph, at least a first lower arm of the pantograph being coupled in an articulated manner to an upper arm of the pantograph via the connecting element of the pantograph.

28. The rail vehicle roof with electrical roof equipment as claimed in claim 27, wherein an electrically insulating lower frame of the pantograph is composed of the first lower arm and a second lower arm of the pantograph; and wherein the connecting element and the upper arm are electrically conductive.

29. The rail vehicle roof with electrical roof equipment as claimed in claim 27, wherein the upper arm is connected to a vertex arm of the pantograph connected to a collector head of the pantograph; and wherein a first connecting strut is disposed between a first flank of the upper arm and the apex arm, and a second connecting strut is disposed between a second flank, disposed opposite the first flank, of the upper arm and the apex arm.

30. The rail vehicle roof with electrical roof equipment as claimed in claim 28, wherein the upper arm is connected to a vertex arm of the pantograph connected to a collector head of the pantograph; and wherein a first connecting strut is disposed between a first flank of the upper arm and the apex arm, and a second connecting strut is disposed between a second flank, disposed opposite the first flank, of the upper arm and the apex arm.

31. The rail vehicle roof with electrical roof equipment as claimed in claim 26, wherein the current-carrying arm is connected in an articulated manner to a third insulator of the pantograph, said third insulator of the pantograph being disposed rotated about an axis parallel to a transverse axis of the rail vehicle roof at an angle to the vertical axis; and
wherein the at least one disconnect switch and the pantograph are disposed in a recess of the rail vehicle roof.

32. The rail vehicle roof with electrical roof equipment as claimed in claim 26, wherein the current-carrying arm is connected in an articulated manner to a third insulator of the pantograph, said third insulator of the pantograph being disposed rotated about an axis parallel to a transverse axis of the rail vehicle roof at an angle to the vertical axis; and
wherein the at least one disconnect switch and the pantograph are disposed in a recess of the rail vehicle roof.

33. The rail vehicle roof with electrical roof equipment as claimed in claim 26, wherein the current-carrying arm is connected in an articulated manner to a third insulator of the pantograph, said third insulator of the pantograph being disposed rotated about an axis parallel to a transverse axis of the rail vehicle roof at an angle to the vertical axis; and
wherein the at least one disconnect switch and the pantograph are disposed in a recess of the rail vehicle roof.

34. The rail vehicle roof with electrical roof equipment as claimed in claim 26, wherein the current-carrying arm is connected in an articulated manner to a third insulator of the pantograph, said third insulator of the pantograph being disposed rotated about an axis parallel to a transverse axis of the rail vehicle roof at an angle to the vertical axis; and
wherein the at least one disconnect switch and the pantograph are disposed in a recess of the rail vehicle roof.

35. A rail vehicle having the rail vehicle roof with electrical roof equipment as claimed in claim 15.
